(19) United States
(12) Patent Application Publication
(10) Pub. No.: US 2026/0037227 A1
(43) Pub. Date: Feb. 5, 2026

(54) SYSTEMS AND METHODS FOR APPLICATION DEVELOPMENT ACCELERATORS

(71) Applicant: Sensia Netherlands B.V., Rotterdam (NL)

(72) Inventors: Chris Wainwright, Wombleton (GB); Jonathan Wun Shiung Chong, Calgary (CA); Thony Brito, Dubai (AE); Hugh Donohoe, Inverurie (GB); Srikanth G. Mashetty, Houston, TX (US); Steve Russell, York (GB); Derek Meier, Katy, TX (US)

(73) Assignee: Sensia Netherlands B.V., Rotterdam (NL)

(21) Appl. No.: 19/240,988

(22) Filed: Jun. 17, 2025

Related U.S. Application Data
(60) Provisional application No. 63/678,307, filed on Aug. 1, 2024.

(51) Int. Cl. G06F 8/20

(52) U.S. Cl. CPC G06F 8/20

(57) ABSTRACT

A system includes a converged controller including a controller portion and a compute portion and a computing platform, the converged controller coupled to at least one field equipment. The computing platform including one or more processors configured to perform operations including providing, based on a user input, an application template, the application template selected from a template library, selecting, based on the user input, a code block from a plurality of code blocks and appending the code block the application template to create an application, installing the application on the converged controller, and executing the application on at least one of the controller portion or the compute portion.

### CROSS-REFERENCE TO RELATED APPLICATIONS

The present application claims priority to U.S. Provisional Patent App. No. 63/678,307 filed on Aug. 1, 2024, the disclosure of which is incorporated herein by reference in its entirety for all purposes.

### BACKGROUND

The present disclosure relates generally to an application developer. More specifically, the present disclosure relates to systems and methods to accelerate development of applications for devices in industrial systems, such as gas and oil extraction stations.

### SUMMARY

At least one implementation of the present disclosure is directed to a system. The system includes a converged controller including a controller portion and a compute portion. The system also includes a computing platform including one or more processors. The one or more processors providing, based on a user input, an application template, the application template selected from a template library, selecting based on the user input, a code block from a plurality of code blocks and appending the code block the application template to create an application, validating, by one or more simulations within a quality controlled environment, the application, wrapping the application, the application configured to function on the converged controller or a cloud computing system, installing the application on the converged controller, and executing the application on at least one of the controller portion or the compute portion.

Another implementation of the present disclosure is directed to a method. The method can include selecting, by one or more processors, based at least partially on user input, an application template from a plurality of application templates. The method can include appending, by the one or more processors, at least one code block to the application template to create an application, the at least one code block selected from a plurality of code blocks based at least partially on the user input. The method can include generating, by the one or more processors, the application using the application template. The method can include wrapping, by the one or more processors, the application. The method can include installing, by the one or more processors, the application on at least one converged controller, the at least one converged controller including at least a controller portion and a compute portion, the at least one converged controller coupled to at least one field equipment. The method can include executing, by the one or more processors, the application on at least one of the controller portion or the compute portion of the at least one converged controller, the application configured to perform at least one of computations using data received from the at least one field equipment or control of operations of the at least one field equipment.

Another aspect of the present disclosure is directed to a system. The system can include a converged controller including a controller portion and a compute portion, the converged controller coupled to at least one field equipment. The system can include a display configured to display a user interface. The system can include a computing platform configured to accelerate creation of an application executable on at least one of the controller portion or the compute portion, the computing platform including one or more processors and one or more non-transitory computer-readable media storing program instructions that, when executed by the one or more processors, cause the one or more processors to perform operations including generating, based on user input received from the display, an application using at least one of an application template or at least one code block selected from a database based on the user input. The one or more processors can perform operations including installing the application on the converged controller. The one or more processors can perform operations including executing at least one of a first portion of the application on the controller portion or a second portion of the application on the compute portion. The one or more processors can perform generating, based on at least an output of the application, data on the user interface.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a converged controller communicating with field equipment, input devices, and output devices, according to some embodiments.

FIG. 4 is a block diagram of a system to including the converged controller and a computing platform, according to some embodiments.

FIG. 5 is a block diagram of a computing platform, which can be implemented by the system of FIG. 4, according to some embodiments.

FIG. 6 is a flow diagram of a method for creating an application, according to some embodiments.

FIG. 7 is a flow diagram of a method for generating application templates, according to some embodiments.

FIG. 8 is a flow diagram of a method for selecting code blocks, according to some embodiments.

FIG. 9 is a flow diagram of a method for deploying applications, according to some embodiments.

FIG. 10 is a flow diagram of a method for executing the application on the converged controller, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, an application development accelerator can be coupled to a control system including various converged controllers. For example, applications developed on the application development accelerator can be installed on one or more of the converged controllers to be used by the control system. The present disclosure relates generally to providing users with an efficient way to develop and validate applications for converged controllers to monitor, collect data, and optimize industrial systems operated by such converged controllers. Approaches herein can provide tools to the user to streamline the process of developing applications to be deployed across one or more converged controllers. For example, the systems and methods can maintain a plurality of application templates and a plurality of code blocks maintained in a database for the user to choose from and build an application off of the application template. In some embodiments, the system can include a physics simulator and/or other virtual testbed for validating application performance. In some embodiments, the systems and methods herein can determine risk and reward metrices for the one or more converged controllers and provide a user with recommendations on which of the one or more converged controllers to deploy the developed application to. In some embodiments, the systems and methods herein can determine which portions of the developed application to deploy to a controller portion and a compute portion of the one or more converged controllers. The teachings herein can accelerate the development, validation, and deployment of applications for the one or more converged controllers to optimize the control of industrial equipment such as oil and gas equipment.

The present disclosure relates to an application development accelerator. While the systems and methods disclosed can be used for developing applications to monitor, control, and collect data on industrial equipment, the systems and methods can also be used for developing applications for a variety of implementations such as applications for mobile devices. The systems and methods herein can continually update and improve with continued user usage and input. The systems and methods herein can provide libraries and examples to support a broad spectrum of applications. For example, the systems and methods can provide documentations and tutorials for building a wide variety of applications from energy usage monitoring to controlling and adjusting process parameters.

### Hydrocarbon Site Overview

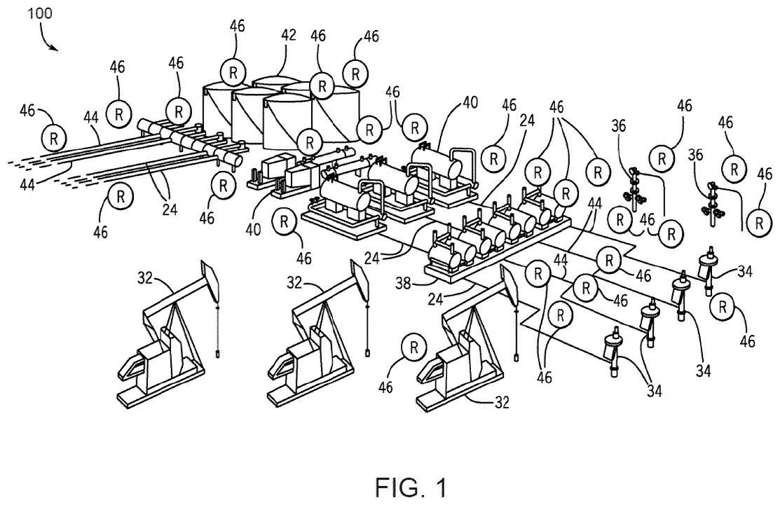

Referring now to FIG. 1, a hydrocarbon site 100 can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

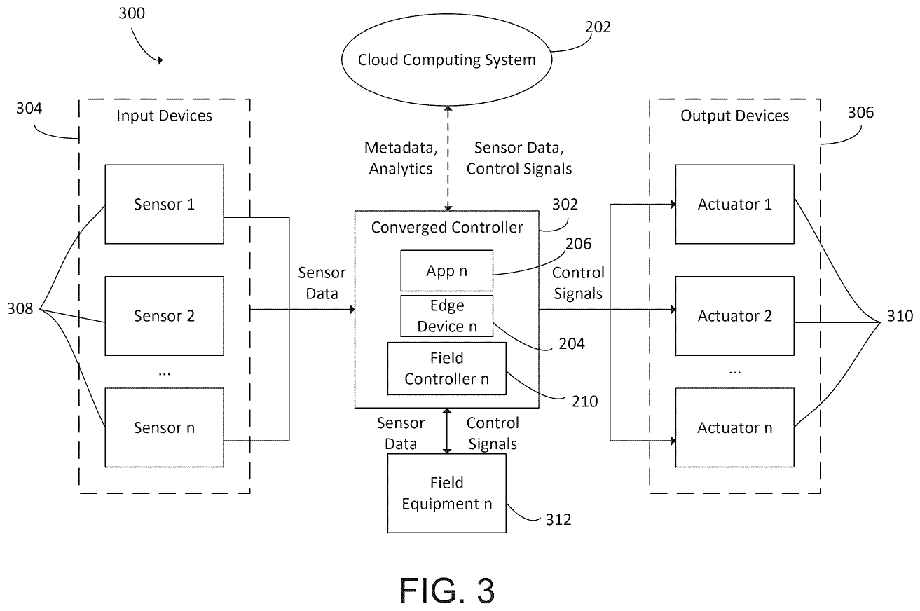

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more converged controllers 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-10 Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the wellhead 30, key performance indicators (KPis) associated with the wellhead 30, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

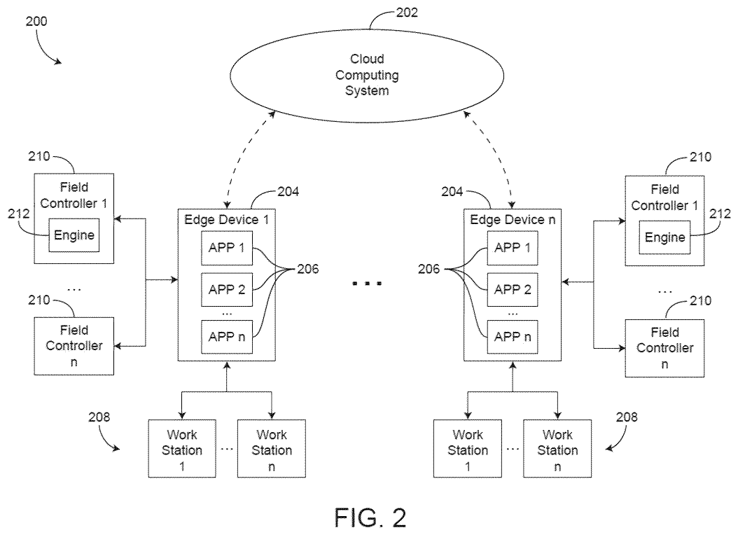

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuity, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

Edge devices 204 may be configured to run, perform, implement, store, etc., one or more applications 206 thereof. Application (n) 206 indicates any number of the application 206 can be run on the edge devices 204. Additionally, some or all processing circuity, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., system 200).

Field controllers 210 may be configured to control various operations at a well site and are communicably coupled with edge devices 204. In some embodiments, field controllers 210 are configured to operate (e.g., provide control signals to, provide setpoints to, adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single workstation 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Converged Controller

Referring now to FIG. 3, control system 300 for performing control of output devices 306 based on input devices 304 is shown, according to exemplary embodiments. Control system 300 is shown to include a converged controller 302 including edge device 204, application 206, cloud computing system 202, field controller 210, field equipment 312, input devices 304, and output devices 306. Field equipment (n) 312 indicates that any number of the field equipment 312 can be included in the control system 300.

The converged controller 302 can be a device configured to function as and include the edge device 204 and the field controller 210. In some embodiments, the converged controller 302 includes all the functionality of the edge device 204 and the field controller 210. For example, the converged controller 302 can both control equipment and optimize performance of the equipment. The converged controller 302 can be, for example, a HCC2 controller manufactured by Sensia LLC in some embodiments. The HCC2 controller can include analog acquisition hardware and software. In some embodiments, the converged controller 302 includes wired or wireless communication interfaces (e.g., jacks, antennas, transmitters, receivers, transceivers, transmitters, wire terminals, etc.) for conducting data communications with various edge devices, RTUs, converged controllers, and/or cloud computing system 202. For example, the converged controller 302 can include a Wi-Fi transceiver, cellular, or mobile phone communication transceivers for communication via wireless communication network.

Input devices 304 may be configured to provide various sensor data and/or field measurements from hydrocarbon site 100 to the converged controller 302 for processing. For example, sensor 308 of input devices 304 is measuring the pump speed of pump 34. Sensor 308 provides the pump speed of pump 34 to converged controller 302 at regular intervals (e.g., continuously, ever minute, every 5 minutes, etc.). Input devices 304 may be connected wired or wirelessly to converged controller 302 or any other device within system 300. In some embodiments, input devices 304 are coupled to various site equipment (e.g., pumps, pump jacks, cranes, etc.) and provide operational data of their respective site equipment to converged controller 302.

In some embodiments, sensor(s) 308 refer to physical sensors (e.g., temperature sensors, flow sensors, etc.) and/or virtual sensors (e.g., inferential sensors, soft sensors, etc.). In some embodiments, virtual sensors provide identical or similar information as would a physical sensor, only via software applications. In some embodiments, virtual sensors learn to interpret the relationships between the different variables and observe readings from various instruments. For example, rather than implementing several physical sensors at a site (e.g., hydrocarbon site 100), one or more virtual sensors may be placed on a simulation model to achieve identical or similar results.

Output devices 306 may be configured to receive control signals from converged controller 302 and adjust operation based on the received control signals. For example, converged controller 302 determines that pump 34 is operating at a lower pump speed than is considered optimal. The converged controller 302 subsequently sends a control signal to actuator 310 to increase pump speed for pump 34. In some embodiments, output devices 306 are configured to act as any device (e.g., actuator, etc.) capable of adjusting operation of site equipment within hydrocarbon site 100. In some embodiments, various other field equipment (e.g., field equipment 312) include some or all of the functionality of input devices 304 and output devices 306 and provide sensor data and receive control signals from converged controller 302. As seen in FIG. 3, sensor (n) 308 and actuator (n) 310 indicates that any number of the sensor 308 and the actuator 310 can be included and used by the control system 300.

In some embodiments, control system 300 is configured to analyze various sets of data (e.g., metadata) to determine control schema that is optimal for hydrocarbon site 100. A significant amount of processing for this may be performed by converged controllers (e.g., converged controller 302), instead of processing all metadata analytics in the cloud, as processing the data in on-site or proximate edge devices can decrease latency compared to sending the data to cloud computing system 202 for processing. For example, sensors 308 provide metadata to converged controller 302. Converged controller 302 processes the data to determine the type of data and/or domain from which the data is received and analyzes the data. An application within converged controller 302 e.g., application 206) may analyze the metadata to make decisions about the control schema that would have been otherwise unnoticed by processing within control system 300. For example, application 206 may infer that the data received has been received by a flow meter sensor (e.g., sensor (1) 308), based on the patterns seen in the data and a prior data that converged controller 302 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 308 and sensor (2) 308 may be flow sensors, but from different vendors. As such, sensor (1) 308 may provide data to field controller 210 in a different format than sensor (2) 308. However, application 206 of the converged controller 302 may still be able to standardize the data and determine that both sets of data are from flow sensors, despite the received data being in different formats (e.g., one data set is provided under resource description framework (RDF) specifications, one data set is provided as data objects, etc.). In various embodiments, allowing converged controller 302 to perform some or all of the metadata analytics allows for improved data analytics and control schema without significantly increasing processing latency.

### Application Development Accelerators

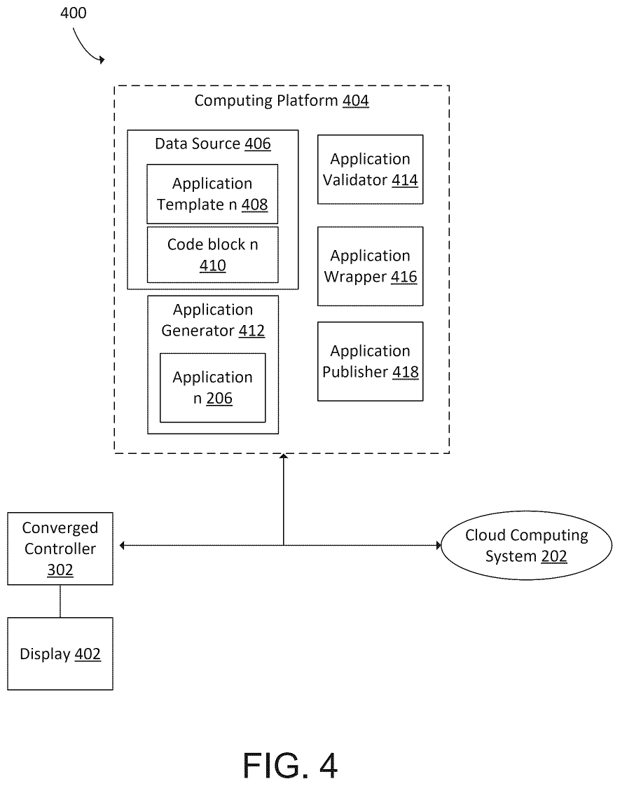

Referring now to FIG. 4, a system 400 is shown, according to some embodiments. System 400 is shown to include a computing platform 404, the cloud computing system 202, and the converged controller 302. In some embodiments, the computing platform 404 is configured to accelerate development of applications (e.g., application 206) for implementation on the converged controller 302. In some embodiments, the computing platform 404 is configured to accelerate development of applications for at least one of the converged controller 302, an edge device (e.g., edge device 204), or a field controller (e.g., field controller 210).

In some embodiments, the converged controller 302 includes a controller portion (e.g., field controller 210) and a compute portion (e.g., edge device 204). For example, the controller portion can control field equipment (e.g., field equipment 312) that the converged controller 302 is connected to while the compute portion analyzes and computes metadata received from the field equipment and/or otherwise provides advanced analytics, algorithms, machine learning, or the like.

The system 400 can include one or more displays 402. The display 402 can be an interface, HDMI interface, a screen, mobile device, etc., that provides supervisory control and data acquisition (SCADA) facilities to the converged controller 302. For example, the display 402 can be a touch screen mounted to the converged controller 302 and allow for user input and control. In some embodiments, the display 402 is separate from the converged controller 302 and communicatively coupled with the converged controller 302. In some embodiments, the display 402 shows the user charts, gauges, SCADA style pages, and other illustrations. The display 402 can show a plurality of SCADA pages to allow for the user to make informed decisions such as whether or not to increase a rate of oil collection. In some embodiments, the display 402 includes a user interface and visually represents an application development workflow which includes application examples, libraries, and APIs. The user interface can include language such as “gauge” and “trend” graphs.

Still referring to FIG. 4, the system 400 can include one or more computing platforms 404. The computing platform 404 can be configured to accelerate creation of an application executable on at least one of the controller portion or the compute portion of, for example, the converged controller 302. The computing platform 404 can include one or more processors and one or more non-transitory computer-readable medium storing program instructions to be executed by the one or more processors to provide the operations attributed to the computing platform 404 or its components herein. For example, the computing platform 404 can receive user input from the display 402 and execute an operation as indicated by the user as described herein. Various functions described with reference to the components of the system 400 described further herein can be performed in various orders and/or combined or moved to other components of the system 400.

The applications (e.g., application 206) created by the computing platform 404 can be implemented on the converged controller 302 and configured to analyze metadata to make decisions about a control scheme that would have been otherwise unnoticed by processing within by, for example, the field controller 210. The metadata can include sensor data, store operational data, operational data of equipment at a physical site, etc. For example, the application 206 can infer that metadata received was received from a sensor (e.g., sensor (1) 308) based on patterns seen in the metadata and previous metadata analyzed by the converged controller 302. The application 206 can make inferences, predictions, and calculations based on current and/or past data. In some embodiments, the application 206 provides some or all of the metadata to the cloud computing system 202 for further processing. In various embodiments, allowing the converged controller 302 to perform some or all of the metadata analytics allows for improved data analytics and control schema without significantly increasing processing latency.

The computing platform 404 can generate the application 206 according to user input. The user input can include at least one of parameters of the application 206 or a goal of the application 206. The parameters can include, for example but not limited to, application size, execution time, load time, cache limits, or any other application parameter. The goal of the application 206 can be a purpose or target of the application 206, such as generating graphs based on data analytics, controlling one or more components of a physical system such as the hydrocarbon site 100, or generating calculations and predictions. In some embodiments, the goal of the application 206 can include the type of the physical system, such as but not limited to a well, pump, pumpjack, etc. (e.g., any type of field equipment 312). In some embodiments, the computing platform 404 can include at least one machine learning model to process the user input. For example, the machine learning model can receive the user input and tokenize characters included in the user input.

The application 206 can generate an output including data for display on the display 402. For example, the application 206 can generate data including metadata analytics, parameters of equipment the converged controller 302 is coupled to, graphs based on the analytics, and other such data. As another example, the application 206 can generate data regarding performance of the application 206, such as load time or bandwidth, for display on the display 402. The application 206 can generate user interface elements, such as gauge and trend graphs for display on the display 402. The application 206 can receive metadata from the, for example, field equipment 312, and can generate data for display on the display 402 according to the metadata and computations performed on the metadata. The user can monitor the display 402, and adjust control of the converged controller 302 accordingly based on the application 206. For example, the user can use the application 206 via the user interface on the display 402 to control the converged controller 302.

The computing platform 404 can include one or more data sources 406. The data sources 406 can include any of various databases, data sets, or data repositories, for example. The data source 406 can be maintained by one or more entities, which may be entities that maintain the system 400 or may be separate from entities that maintain the system 400. For example, the data source 406 can be maintained by the cloud computing system 202. The data source 406 can receive data from at least one of the user, third parties, or the cloud computing system 202.

In some embodiments, the data source 406 includes a plurality of application templates 408 (e.g., a template library). The application templates 408 can be based on existing applications with proven usability (e.g., applications 206 currently being used on edge devices, field controllers, and/or converged controllers). The data source 406 can maintain a database of the plurality of application templates 408 and can continuously update the database based on users developing new applications. Following application deployment, the plurality of application templates 408 can be updated based on an operation and functionality of the deployed application. For example, if the application 206 provides accurate data as programmed following deployment, a template of the application 206 can be added to the plurality of application templates 408. In some embodiments, the data source 406 can also include application templates 408 from third parties and received through the cloud computing system 202. As seen in FIG. 4, application template (n) 408 indicates any number of the application template 408 can be stored by the data source 406.

In some embodiments, each of the plurality of application templates 408 is associated with a plurality of code libraries. For example, a graph creating application is associated with graph generating code libraries. Each of the plurality of application templates 408 can correspond to a plurality of tags. For example, the plurality of application templates 408 are given tags based on functionality, storage, etc. In this case, the plurality of application templates 408 can be filtered based on the tags. In some embodiments, the plurality of application templates 408 can be associated with by at least one of a goal of the application 206. For example, the plurality of application templates 408 can be categorized and associated with computations including performing calculations and generating predictions or controls such as controlling equipment.

In some embodiments, the plurality of application templates 408 includes hard real time modules which can be used for applications with strict timing limitations. In this case, the application template 408 can include fast feedback control loops and safety protection trips. This can also be implemented as a traditional programmable logic controller (PLC)-type programming at an input/output (I/O) board level. In some embodiments, the plurality of application templates 408 includes soft real time modules which can be for applications with flexible timing limitations. In this case, the application template 408 can include containerized modules with machine learning which can communicate with other modules such as soft PLCs via message bus which can be implemented on a computer processing unit (CPU). In some embodiments, the hard real time modules can interact with the soft real time modules to execute control actions.

In some embodiments, the application template 408 can be generated based on a goal of the application 206. For example, responsive to determining that the goal is to optimize power usage, the application template 408 can be generated based on analyzing and adjusting power. In this case, the application template 408 can be associated with machine learning libraries to facilitate analysis of the input data to improve control of the outputs. As another example, responsive to determining that the goal is to monitor well testing, the application template 408 can include data storage and reporting facilities (e.g., modules) and be associated with libraries that provide other such modules.

In some embodiments, the data source 406 includes a plurality of libraries, protocols, documentation, tutorials, and helper applications. The libraries can include, for example, protocols for the HCC2. The data source 406 can receive third party submissions and allow for users to develop protocols and submit the protocols for inclusion in the data source 406. The protocols can then be enabled for deployment to, for example, the converged controller 302. In some embodiments, elements of the data source 406 can be monetized. For example, monetization can occur through per development or per deployment seat licensing of an application.

In some embodiments, the computing platform 404 selectively downloads protocols from the data source 406 to allow for a user to begin developing applications (e.g., application 206) with a reduced package time to efficiently manage space and resources. For example, depending on a type of application 206 the user is creating, certain protocols are automatically downloaded. The user can browse (e.g., search) the data source 406 and determine which of the plurality of libraries, protocols, documentation, tutorials, and helper applications to use. In some embodiments, the data source 406 includes an application store which includes a plurality of the application 206 available for installation.

In some embodiments, the data source 406 includes a plurality of code blocks 410 (e.g., a code block library). The plurality of code blocks 410 can each correspond to a function and/or pre-existing code. For example, one of the plurality of code blocks 410, when appended to the application template 408, can add an additional function to the application template 408 such as exporting a graph to be shown on the display 402. The plurality of code blocks 410 can be implemented on a browser-based toolset. For example, a code block of the plurality of code blocks 410 can be implemented by searching for a keyword associated with the code block such as “Boolean”. In some embodiments, the plurality of code blocks 410 reduces an overhead in memory compared to Docker containers. For example, each of the code blocks 410 contains code while containers contain code, libraries, etc. The plurality of code blocks 410 can decrease an implementation time of features the user desires the application 206 to have. For example, instead of typing out code for the application 206, the user can add the code block 410 to the application template 408 instead. As seen in FIG. 4, code block (n) 410 indicates any number of the code block 410 can be stored by the data source 406.

In some embodiments, each of the application templates 408 can be associated with at least one of the code blocks 410. In some embodiments, the plurality of code blocks 410 can be associated with at least one of parameters or goals of the application 206. For example, a subset of the plurality of code blocks 410 can be associated with a range of application sizes of the application 206 according to the user input.

The plurality of code blocks 410 can include data quality code blocks. For example, the data quality code blocks include functions to detect missing values, frozen values, outliers, specific ranges, and sensor integrity detection. For example, the data quality code block receives metadata (e.g., from the sensor (1) 308) as an input and identify outliers within the metadata. The plurality of code blocks 410 can also include reference engine code blocks. The reference engine code blocks can adapt to determine new normal for drifting and/or evolving systems (e.g., system 300). For example, the reference engine code block can store previous versions of the application 206 and datasets received from, for example, the field equipment 312, and compare previous versions with current versions of the datasets. In some embodiments, the reference ending code block can process data in real time. For example, smart analytics or signal processing can determine what a latest (e.g., current) normal state for the system (e.g., the system 300) is using data streams. The data streams can then be used to track slow or fast moving changes and differentiate the changes (e.g., between slow and fast). The reference engine code block can thus store all the changes which can then be used to determine thresholding alarms for evolving signals and/or states of the system. The thresholding alarms can be, for example, a threshold that triggers an alarm if the changes of the signals and/or states of the system satisfy the threshold.

The plurality of code blocks 410 can also include smart buffering code blocks. The smart buffering code blocks can average values before feeding the data into the application 206, collect data for training machine learning models stored within the application 206, remove noise, etc. For example, the smart buffering code block can normalize and clean data prior to inputting the data into the machine learning model, for example by aligning data received at different frequencies from multiple data sources (e.g., sensors) into a common timeseries. In some embodiments, the smart buffering code blocks reduce a time and processing power needed for the application 206 to perform further functions on the buffered data and/or otherwise enables further data processing and analytics. The plurality of code blocks 410 can also include anomaly detection code blocks. The anomaly detection code blocks can detect general deviations from reference and noise thresholds. For example, the anomaly detection code block can analyze a dataset (e.g., metadata) to determine a typical noise threshold, set an upper noise threshold, and detect when the noise exceeds the upper noise threshold.

In some embodiments, the data source 406 includes an object library configured for efficient and standardized user interfaces on, for example, the display 402. The object library can increase efficiency of the application 206 implementation on user interfaces. In some embodiments, the object library functions and replicates for the converged controller 302 and the cloud computing system 202.

Referring further to FIG. 4, the computing platform 404 can include one or more application generators 412. The application generator 412 can receive and search through the plurality of application templates 408 and the plurality of code blocks 410 stored by the data source 406. The application generator 412 can output and create an application (e.g., the application 206) using at least one of the user input, the plurality of application templates 408, or the plurality of code blocks 410. The converged controller 302 may be configured to run, perform, implement, store, etc., one or more applications 206 thereof. In some embodiments, the application generator 412 allows the user to select an application template 408 from the plurality of application templates 408 and provides the application template 408 to the user to begin creating an application. Each application template 408 of the plurality of application templates 408 can be associated with code libraries (e.g., Keras, a neural network library). In some embodiments, the application generator 412 includes a generative machine learning model. The generative machine learning model can be trained on the plurality of application templates 408, receive input from the user, and generate an application template 408 along with code libraries suited for the generated application template 408. Input from the user can include, for example, desired functionality of the application 206 or parameters, among others. In some embodiments, the generative machine learning model can generate the application 206 based on the user input by parsing and tokenizing characters included in the user input.

In some embodiments, a portion of the plurality of code blocks 410 is associated with each of the plurality of application templates 408. For example, the application generator 412, based on a chosen application template 408, can recommend which of the plurality of code blocks 410 to append to the application template 408. This can be based on at least the user input such as responsiveness, efficiency, and determinism. The plurality of code blocks 410 can also be assigned to the plurality of tags. The plurality of tags can correspond and link the portion of the plurality of code blocks 410 to the plurality of application templates 408. For example, data quality code blocks can be given tags and associated with application templates 408 for analyzing data received from, for example, the sensor 308. In some embodiments, the application generator 412, based on at least the user input, selects the application template 408 and selected code blocks 410 associated with at least one of the user input or the application template 408 to append to the application template 408 to generate the application 206.

In some embodiments, the user can search, select, and append a code block of the plurality of code blocks 410 to the application template 408. Appending the plurality of code blocks 410 customizes and changes a function and output of the application 206 from the application template 408. In some embodiments, the application generator 412 includes a side bar on a user interface (e.g., display 402) and contains the plurality of code blocks 410 which the user searches through. In some embodiments, the application generator 412 includes a library on a user interface and contains the plurality of application templates 408 for the user to select from.

In some embodiments, the application generator 412 uses a Compute+Soft+Hard PLC combination programming language. The programming language can combine soft, hard, and computational programming to facilitate a combination of messaging and traditional communications within, for example, the converged controller 302, containers, and embedded software. For example, the plurality of code blocks 410 can represent a combination programing language. This can allow for combining different programming technologies (e.g., languages) with the converged controller 302 (e.g., third party PLC code combined with a docker container application for the converged controller 302). For example, an example system can include a signal analyzer application template 408 which uses the third party PLC code to capture signals that are then passed to a compute site application 206 for processing or analysis using artificial intelligence (AI) or machine learning (ML). In this case, both the signal analyzer application template 408 and the compute site application 206 are packaged as code blocks 410 in one or more of the application templates 408. The signal analyzer application template 408 and the compute site application 206 can also be associated (e.g., connected). The example system can also store methods of deploying a combined solution (e.g., the signal analyzer application template 408 captures signals and the compute site application 206 processes the signals).

Referring still to FIG. 4, the computing platform 404 can include one or more application validators 414. The application validator 414 can receive the application 206 from the application generator 412. For example, once the application 206 is completed by the application generator 412, the application generator 412 then feeds the application 206 to the application validator 414 to validate and qualify the application 206. This can be initiated by the user and/or the system 400. In some embodiments, the application validator 414 includes one or more simulators. The one or more simulators can exist within a quality-controlled environment that mimics a real system (e.g., the hydrocarbon site 100) in terms of synchronization, sampling time, and may connect to actual hardware (e.g., actuators). The simulators can test and qualify the applications 206 with real world simulators to measure a performance of the applications 206 prior to releasing the applications 206 for use in industrial sites (e.g., the hydrocarbon site 100). The simulators can include, but not limited to, converged controller simulators, network simulators, browser-based simulators, etc. to simulate and test real world performance of the application 206.

For example, the simulators can include a physics simulator and test how the application 206 responds to dynamic and steady state situations. The physics simulator can provide flow rates and test a flow monitoring and controlling application (e.g., application 206). The simulators can also include a logic simulator to test and qualify a logic of the application 206. The simulators can provide a variety of situations such as, for example, a component of the system (e.g., the hydrocarbon site 100) fails and the system begins to malfunction.

In some embodiments, the application validator 414 rates the application 206 and determines whether or not the application 206 is ready for release to real world industrial sites. For example, based on a performance of the application 206 to a variety of situations and simulators, the application validator 414 can calculate a score for the application 206, and determine the application 206 is ready for release if the score meets or is above a passing threshold.

The computing platform 404 can include one or more application wrappers 416. The application wrapper 416 can receive the application 206 from the application validator 414 and wrap the application 206. For example, the application wrapper 416 applies a function to encapsulate and organize elements within the application 206. As a result, the application 206 is configured to function on both the cloud computing system 202 and the converged controller 302 and any other device (e.g., the edge device 204). For example, following wrapping by the application wrapper 416, the application 206 originally designed to perform on the cloud computing system 202 can now perform on both the cloud computing system 202 and the converged controller 302. Wrapping of the application 206 causes the application 206 to be agnostic to data sources (e.g., the data source 406) as well as to consider data rates, synchronization of states whether operating on the cloud computing system 202 or the converged controller 302, data abstraction for consistency throughout, and data storage which enables common access methods for both the converged controller 302 and in the cloud computing system 202.

In some embodiments, the application 206 can be designed to be executable only on the cloud computing system 202. In some embodiments, the application 206 can be designed to be executable only on the converged controller 302.

Still referring to FIG. 4, the computing platform 404 can include one or more application publishers 418. The application publisher 418 can receive the application 206 from the application wrapper 416. The application publisher 418 can both publish the application 206 to, for example, a library stored within the data source 406 and allow for the application 206 to be installed and executed on a plurality of the converged controller 302. The application publisher 418 can allow the application 206 to be executed on at least one of the controller portion or the compute portion of the converged controller 302. For example, the data source 406 can include the application store and allow the application publisher 418 to publish (e.g., upload) the application 206 to the application store to be viewed and downloaded by users. Additionally, the application publisher 418 can allow the application 206 to be installed on at least one converged controller 302.

In some embodiments, the application publisher 418 generates a prioritized list of a plurality of devices (e.g., converged controllers 302, edge device 204, field controller 210) from the data source 406. For example, the data source 406 stores a list of the plurality of converged controllers 302 available to the user. The application publisher 418 can then, based on risk and reward metrices associated with the plurality of converged controllers 302, recommend which of the plurality of converged controllers 302 to download and execute the application 206 to. For example, if one of the plurality of converged controllers 302 has a high risk associated with it (e.g., monitoring equipment failure), the application publisher 418 recommends to not download and execute the application 206 to a high risk converged controller 302 first, but rather, recommends the user to download and execute the application to the converged controller 302 with a lower risk (e.g., monitoring electricity usage).

The risk and reward metrices can be based on an equation and involve factors such as geographical location, type of industrial site (e.g., the hydrocarbon site 100), role of the converged controller 302, etc. The risk and reward metrices can also be quantified by any combination of production output and/or rates (e.g., oil output and/or rate), cost of failure (e.g., monetary cost), cost of maintenance, potential for efficiency gains, cost of communications and/or bandwidth, available computational resources (e.g., storage and performance), and needs of the application 206 (e.g., bandwidth, memory, etc.).

In some embodiments, the risk and reward metrices can be determined by user input. For example, the user can mark one of the converged controller 302 as critical (e.g., high risk) or not critical (e.g., low risk or high reward). In this case, to update and/or deploy the application 206 to the converged controller 302, user consent must be received (e.g., the user approves deployment of the application 206). In some embodiments, the risk and reward metrices can be determined by resource usage. For example, if a new application 206 needs a large amount of CPU time, memory, and data communication bandwidth compared to the application 206 already installed and deployed on a system (e.g., the system 300), or requires physical inputs, the application 206 can be marked as high risk. The parameters can then be compared with available resources of each of the plurality of converged controllers 302. The application 206 can thus be deployed based on which of the plurality of converged controllers 302 has the resources to download and execute the application 206. The resources can also include sensors. Availability of sensors can impact, for example, accuracy, uncertainty, and confidence of model prediction quality within the application 206. In some embodiments, risk and reward metrices associated with each of the plurality of converged controllers 302 are stored in the data source 406. In some embodiments, the risk and reward metrices are determined when the converged controller 302 is connected to the computing platform 404.

In some embodiments, the application publisher 418 can recommend which of the plurality of converged controllers 302 to deploy the application 206 to based on the goal of the application 206. For example, a well site monitoring application 206 can be recommended to be deployed to a well site converged controller 302. In this case, the well site converged controller 302 can be marked as high reward based on the goal of the well site monitoring application 206. The application publisher 418 can generate recommendations which can be a subset of the plurality of converged controllers 302. In some embodiments, the generate recommendations can generate the recommendations based on the list of the plurality of converged controllers 302 (e.g., devices). In some embodiments, the application 206 can be deployed based on a novelty of the application 206. For example, the application publisher 418 can determine if the application 206 is similar to an application 206 in the library, and recommend the application 206 for deployment based on the novelty. In some embodiments, the risk and reward metrices are based on a hierarchy of the application 206. The hierarchy can range from hardware level applications 206 to user interface (UI) applications 206. For example, the UI application 206 can be marked as high reward while the hardware level application 206 is marked as high risk. This can be based on an impact that the application 206 can have on a system (e.g., the system 300).

In some embodiments, the application 206 can be installed according to the recommendation. For example, the application publisher 418 can receive user input on the recommendations, and install the application 206 on the subset of the plurality of converged controllers 302 according to the recommendation.

In some embodiments, the application publisher 418 determines whether or not the application 206 should be published to the application library. For example, if the application 206 fails the application validator 414 simulations, the application publisher 418 blocks the application 206 from being published. The application publisher 418 can include an approval process and/or an approval rating for the application 206 to be published and executed. In some embodiments, the application publisher 418 provides the application 206 with a rating. For example, if the application 206 publishes to the application store, the rating is shown to the user.

In some embodiments, the application publisher 418 provides recommendations to the user on which of the plurality of converged controllers 302 the application 206 should be installed and executed on. For example, if the application 206 involves displaying a plurality of graphs to the display 402 involving oil production, the application publisher 418 recommends the user to install the application 206 to the plurality of converged controllers 302 related to oil production and connected to at least one of a plurality of displays 402. In some embodiments, the application publisher 418 takes into account the function, storage space, processing power, metadata, etc. of the application 206 to provide recommendations to the user.

The application publisher 418 can also, in some embodiments, determine if the application 206 should be executed on the controller portion, the compute portion, or both of the converged controller 302. For example, if the application 206 contains a mix of functions executed by both the controller portion and the compute portion, the application publisher 418 assigns different portions of the application 206 to be executed by the controller portion and the compute portion accordingly.

In some embodiments, the application 206 can be validated following installation of the application 206 on a converged controller 302. For example, the application publisher 418 can recommend the user to install the application 206 on one converged controller 302 to first test and qualify the application 206. Following installation of the application 206 by the user, at least one of the application publisher 418 or the application validator 414 can monitor performance of the application 206 and in some embodiments, can cause a system to run at specific parameters to validate the application 206. For example, the application 206 can be installed on a converged controller 302 configured to control a well of the hydrocarbon site 100. At least one of the application publisher 418 or the application validator 414 can control, for example, a pump to operate at different pump speeds to test performance of the application 206.

In some embodiments, at least one of the application publisher 418 or the application validator 414 can include a validation threshold. The at least one of the application publisher 418 or the application validator 414 can determine performance of the application 206 while installed on a physical system such as a well, and compare the performance to the validation threshold. The performance can include metrics, such as but not limited to stability in controls, responses, and time and accuracy of performance. In response to the performance being at or above the validation threshold, the at least one of the application publisher 418 or the application validator 414 can validate the application 206 for use on the physical system. In response to the performance being below the validation threshold, the at least one of the application publisher 418 or the application validator 414 can notify the user and transmit the application 206 to the application generator 412 for adjustment. The application generator 412 can adjust and tune the application 206 according to at least one of the performance or user input. In some embodiments, the at least one of the application publisher 418 or the application validator 414 can generate a validation score based on the performance of the application 206, and provide the validation score to the display 402. The validation score can be determined based on the performance, and can indicate whether the application 206 was validated, and the performance of the application 206.

In some embodiments, in response to the application 206 being below the validation threshold, the application publisher 418 can remove the application 206 from an application store. In some embodiments, in response to the application 206 being at or above the validation threshold, the application publisher 418 refrains from removing the application 206 from the application store. In some embodiments, the application publisher 418 can add the validation score of the application 206 for view in the application store.

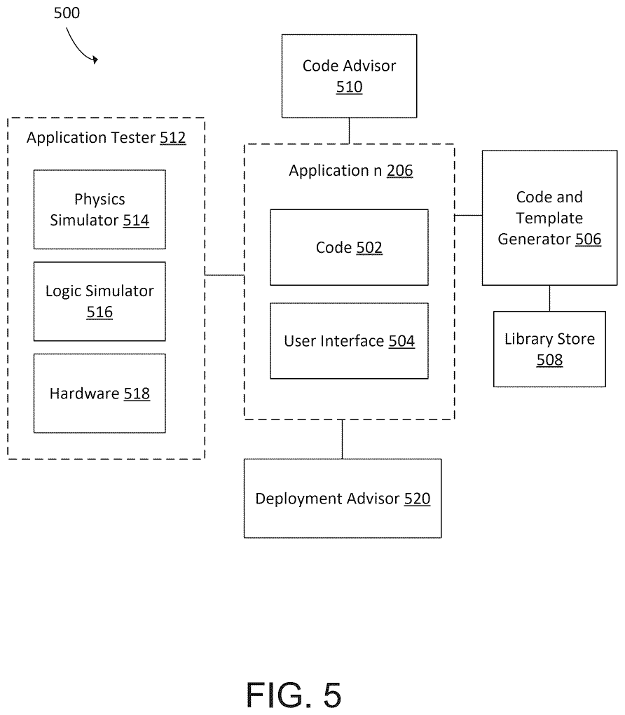

Referring now to FIG. 5, a block diagram of a system 500 for accelerating application development is shown, according to some embodiments. The system 500 can be, for example, a computing platform for accelerating application development. The system 500 can be provided via programming instructions stored on one more non-transitory readable media and one or more processors operable to executing such programming instructions to perform the operations described herein and provide the models, system identification, predictions, reinforcement learning, constraint filters, etc. shown in FIG. 5 and described herein. The system can be provided on hardware at the edge (e.g., provided as part of, physically coupled to, and/or in geographic proximity to actuators, sensors, and/or the physical system), via remote computing resources (e.g., cloud resources, remote servers, geographically away from one or more actuators, sensors, and/or the physical system, etc.) for example communicable via the Internet or other network with one or more actuators, sensors, and/or the physical system, and/or distributed across any combination of such computing devices.

For example, the elements of FIG. 5 may be provided by, on, as part of, etc. the converged controller 302, the cloud computing system 202, and/or the computing platform 404. Elements of FIG. 5 may be performed on and/or integrated with elements of FIG. 4, such as the computing platform 404. Various functions described with reference to the components of the system 500 described further herein can be performed in various orders and/or combined or moved to other components of the system 500. In some embodiments, the system 500 incorporates some or all of the features and functionality of the system 400 as disclosed above with reference to FIG. 4, and vice versa.

The system 500 can be integrated with the converged controller 302, the cloud computing system 202, and/or the display 402. The system 500 can include an application (e.g., the application 206). The application 206 includes code 502 and, in some embodiments, a user interface 504. For example, the code 502 can begin with a code template and the user can add additions to the code template such as the code block 410. The user could also, for example, add comments, adjust logic of the code template, and make other customizations. In some embodiments, the user interacts with the user interface 504 to make adjustments to the code 502. For example, the application 206 could be viewed on a display (e.g., display 402), and the user can view the code 502 and make adjustments accordingly. In some embodiments, the user interface 504 includes third party SCADA editors to increase a speed of design and adoption of the application 206. In some embodiments, the user interface 504 is a user experience design of the application 206 following deployment and installation of the application 206. In some embodiments, the library store 508 includes an object library with elements for the user interface 504. The user interface 504 can be designed by, for example, the object library.

In some embodiments, the user interface 504 can be displayed on the display 402. The user can provide user input to the system 500 via the user interface 504. In some embodiments, the application 206 generates data following installation and generates user interface elements indicative of the data for display on the user interface 504. For example, the application 206 can generate data indicative of results of metadata analysis for display on the user interface 504.

In some embodiments, the user can generate and/or make adjustments to the code 502 with the code and template generator 506. The code and template generator 506 can be coupled to a library store 508 and generate code templates and code functions for the application 206. The library store 508 can include, for example, a plurality of code libraries, code functions, tutorials, etc. In some embodiments, the code and template generator 506 can select a code template and code libraries from the library store 508 to be included in the code 502. The code and template generator 506 can also provide recommendations for code templates based on a user input, suggest code libraries based on the selected code template, and recommend code blocks and/or functions (e.g., code block 410) based on the user input. In this case, the user input can include desired functionality of the application 206.

In some embodiments, the code and template generator 506 is a machine learning model and uses the library store 508 as training data. In this case, the code and template generator 506 receives user input to generate a code template for the code 502. The code and template generator 506 can also generate code libraries and code blocks 410 associated with the generated code template. In some embodiments, the application generator 412 can include the code and template generator 506.

In some embodiments, the user interface 504 is configured to allow the user to make adjustments and customize the code template to create the code 502 by adding code blocks (e.g., code block 410). The code blocks can be function blocks that alter a performance and functionality of the code template. The user can select the code block from the library store 508 and/or the code and template generator 506 can provide the user with code blocks. In some embodiments, the code and template generator 506 is initiated through the user interface 504, and the library store 508 is viewed and interacted with through the user interface 504. For example, the library store 508 can be a screen on the user interface 504 in which the user can drag, for example, the code block to the code 502 and edit the code 502.

Referring still to FIG. 5, the system 400 can include one or more code advisors 510. The code advisor 510 can receive the code 502 as an input and recommend additional functions, libraries, edits, etc. to the code 502 based on design requirements for the application 206 provided by the user. For example, the user can initiate the code advisor 510 through the user interface 504 and the code advisor 510 may recommend using a container that enhances the application 206. For example, a machine learning module to analyze data produced by the application 206 may be input into a container. The user can also input the design requirements into the code advisor 510 to provide recommendations which can be, for example, a maximum storage the application 206. In some embodiments, the application generator 412 can include the code advisor 510.

In some embodiments, the code advisor 510 is coupled to the code and template generator 506 and the library store 508. The code advisor 510 can compare the code 502 to codes within the library store 508 and templates generated by the code and template generator 506 and, in some embodiments, provide recommendations on edits to the code 502. The code advisor 510 can filter and search through the library store 508 based on the design requirements for the application 206. In some embodiments, the code advisor 510 can provide the code and template generator 506 with training data such as previous codes (e.g., code 502). Both the code advisor 510 and the code and template generator 506 can be machine learning models and trained on previously created applications (e.g., application 206), and updated based on current and/or new applications.

The system 500 can include one or more application testers 512. The application tester 512 can receive the application 206 and run the application 206 through simulations. The application tester 512 can be initiated by the user through the user interface 504. In some embodiments, the system 500 sends the application 206 to the application tester 512 after an indication of completion by the user. The simulations can include the physics simulator 514 and the logic simulator 516 in a quality-controlled environment. The physics simulator 514 can test how the application 206 would perform in a real-world scenario. For example, if the function of the application 206 is to monitor electricity usage of a hydrocarbon site, the physics simulator 514 can simulate conditions of the hydrocarbon site and compare results of the application 206 to actual results in the simulated world. As another example, if the function of the application 206 is to control pumps or other field equipment of a hydrocarbon site, the physics simulator 514 can provide a robust range of physical conditions which may occur and enable simulation of the ability of the application 206 to efficiently control such pumps or other field equipment under such various physical conditions. In some embodiments, the application validator 414 can include the application tester 512.

The application tester 512 can also test the logic of the application 206 (e.g., the code 502) through the logic simulator 516. The logic simulator 516 can run the code 502 and determine if there are any errors in the logic. In some embodiments, both the physics simulator 514 and the logic simulator 516 are coupled to a hardware 518 (e.g., an actuator, a sensor, etc.). The hardware 518 can mimic real systems in terms of synchronization and sampling time in a quality-controlled environment. In this case, the application tester 512 can also test the processing speed, power, etc. of the application 206. In some embodiments, based off of the results of the application tester 512, the code advisor 510 may recommend different functions and edits to the code 502.

In some embodiments, in response to the application tester 512 determining that the application tester 512 lacks a simulation to simulate at least one of the goal or parameter of the application 206, the application tester 512 can validate the application 206 on a physical system. For example, the application tester 512 may not include a simulation including desired testing parameters of the application 206, and the application 206 can be installed on the converged controller 302 and validated on the field equipment 312 that the converged controller 302 is coupled to. Based on the performance of the application 206, the application 206 can be tuned and adjusted by, for example, the code advisor 510.

Still referring to FIG. 5, the system 500 can include one or more deployment advisors 520. Following completion of the application 206 as indicated by the user, the deployment advisor 520 can generate a list of devices (e.g., edge devices 204, converged controllers 302) for the application 206 to be released to. For example, the list of devices can include the devices owned and in use by the user. The devices can be located in different geographical locations and span a variety of purposes such as an edge device at an oil drilling site or a converged controller at a hydrocarbon site. In some embodiments, the list is created based on prioritizing the devices based on risk and reward matrices. For example, devices that are more important to an industrial site (e.g., controlling power to the site) may be ranked as higher risk. The deployment advisor 520 can recommend which devices to install and execute the application 206 on. The deployment advisor 520 can also filter devices based on the functionality of the application 206. In some embodiments, the application 206 is first installed and executed on a single device to test and qualify the application 206 in the real world.

In some embodiments, the application 206 is installed in an order based on the risk and reward metrices of the plurality of converged controllers 302. For example, a first converged controller 302 has a lower risk than a second converged controller 302. In this case, the application 206 will first be installed on the first converged controller 302 and then the second converged controller 302. In some embodiments, the application publisher 418 can include the deployment advisor 520.

In some embodiments, the deployment advisor 520 determines which portions of the application 206 should be executed on the compute portion of the device (e.g., converged controller 302) and which portions of the application 206 should be executed on the controller portion of the converged controller 302. For example, if the application 206 receives metadata from, for example, the actuator (1) 310, analyzes the metadata, and outputs a chart, the deployment advisor 520 can assign various portions of the application 206 to be executed on the compute and the controller portion of the converged controller 302. In this case, analyzing the metadata could be executed on the compute portion. In some embodiments, an entirety of the code 502 of the application 206 is executed on either the compute portion or the controller portion of the converged controller 302. In some embodiments, the application 206 is divided into a first portion and a second portion where the first portion is executed on the controller portion and the second portion of the application 206 is executed by the compute portion.

In some embodiments, if the application 206 is successful (e.g., performs with the desired functionality of the application 206), the application 206 is uploaded to the library store 508. The user can submit the application 206 for approval to be added to the library store 508. The application 206 can be fed as training data to the code and template generator 506 and the code advisor 510.

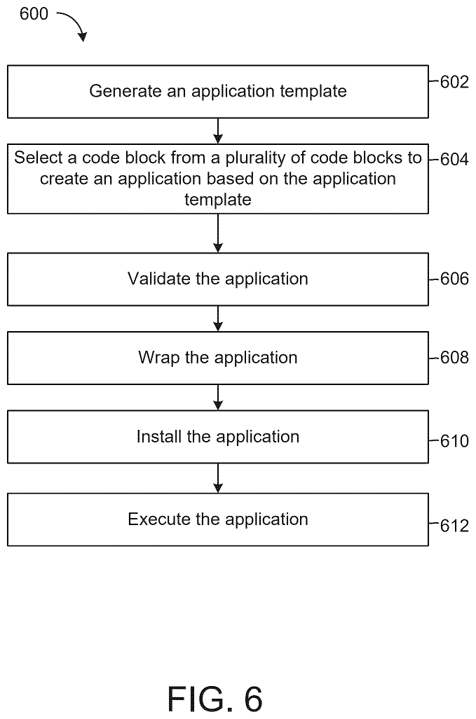

Now referring to FIG. 6, each block of method 600, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 600 is described, by way of example, with respect to the system 400 and/or the system 500. However, these methods may additionally or alternatively be executed by any one system, or any combination of systems, including, but not limited to, those described herein. The method 600 can be performed in any order and can be performed in an order different to than shown in FIG. 6.

At block 602, an application template is generated. The application template can be generated by, for example, the application generator 412 and/or the code and template generator 506. At block 604, a code block is selected from a plurality of code blocks (e.g., code block 410) to create an application by appending the code block to the application template. The code block can be recommended by, for example, the code advisor 510 based on the application template. The user can search through the plurality of code blocks to adjust the application template.

The method 600 also includes validating the application at block 606. The application can be validated to ensure the functionality by, for example, the application validator 414 and/or using the various simulations, tests, etc. described above with reference to the application validator 414. The application can then be wrapped at block 608 so that the application can function on a device, a cloud system, and/or a plurality of devices (e.g., converged controller 302). Following wrapping, the application can be installed on a device at block 610 such as an edge device, an RTU, a mobile device, a computer, a converged controller, etc. In some embodiments, at block 608 in the scenario where the application is to be installed on a converged controller, an automatic assessment and decision can be executed to determine whether the application is to be installed on a compute portion (e.g., edge device 204 of converged controller 302) or control portion (e.g., field controller 210 of converged controller 302) or some combination thereof, and block 608 can include preparing the application to be installed at the compute portion, control portion or appropriately divided therebetween. The application can then be executed and/or run on devices that the application is installed on at block 612.

In some embodiments, the method 600 can include validating the application after installing the application at block 610. For example, the method 600 can include validating performance of the application on the converged controller.

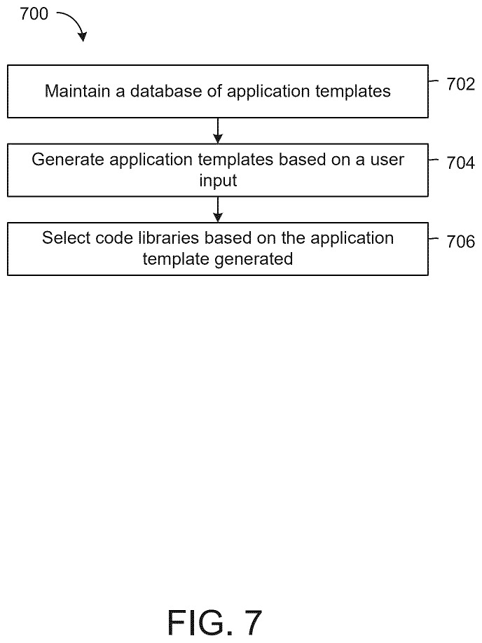

Now referring to FIG. 7, each block of method 700, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 700 is described, by way of example, with respect to the system 400 and/or the system 500. However, these methods may additionally or alternatively be executed by any one system, or any combination of systems, including, but not limited to, those described herein.

The method 700 can be directed to a plurality of application templates stored by, for example, the data source 406. At block 702, a database of application templates is maintained. At block 704, an application template is generated based on user input by, for example, the application generator 412. The user input can include selecting from the database of application templates and/or input into a generative machine learning model to generate the application template. Based on the application template chosen by the user, code libraries can be selected at block 606. For example, if a graph generator application template is chosen, selected code libraries can include a graph-based coding library. The database of application templates can be updated based on third party provided applications.

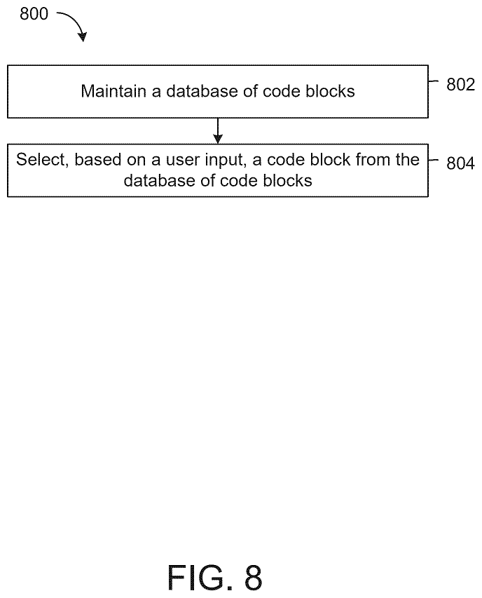

Now referring to FIG. 8, each block of method 800, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 800 is described, by way of example, with respect to the system 400 and/or the system 500. However, these methods may additionally or alternatively be executed by any one system, or any combination of systems, including, but not limited to, those described herein.

The method 800 can be directed to a plurality of code blocks stored by, for example, the data source 406. Each code block of the plurality of code blocks can correspond to a function. For example, a code block can represent an if function. At block 802, the database of code blocks is maintained. The database of code blocks can be updated with additional code blocks. At block 804, a code block is selected from the database of code blocks based on user input. The user input can be selecting from the database of code blocks and/or the block 804 can include a generative machine learning model to generate the code block based on the user input.

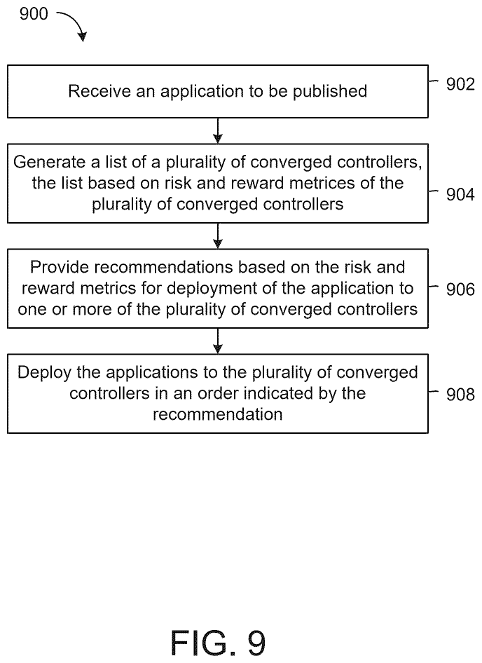

Now referring to FIG. 9, each block of method 900, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 900 is described, by way of example, with respect to the system 400 and/or the system 500. However, these methods may additionally or alternatively be executed by any one system, or any combination of systems, including, but not limited to, those described herein.

At block 902, an application is received to be published. The application can be published by, for example, the application publisher 418. At block 904, a list of a plurality of converged controllers is generated where the list is based on risk and reward metrices of the plurality of converged controllers. Each converged controller of the plurality of converged controllers has risk and reward metrices associated with it. For example, converged controllers deemed to be at more systemically important or centralized locations (e.g., within an oil drilling well) have a higher risk metric as compared to peripheral or otherwise secondary converged controllers (e.g., associated with optional or intermittent operations of a facility). Then, at block 906, recommendations based on the risk and reward metrices of each converged controller of the plurality of converged controllers are provided for deployment of the application to one or more of the plurality of converged controllers. For example, the application can be deployed to one of the plurality of converged controllers for testing. As another example, the application can be deployed to the plurality of converged controllers with high reward metrics (e.g., a graph generating application deployed to converged controllers with a display). At block 908, the application is deployed to the plurality of converged controllers in an order indicated by the recommendation. In some embodiments, the user deploys the application to the plurality of converged controllers not indicated by the recommendation. The user can alter the recommendation and deploy the application to any of the plurality of converged controllers.

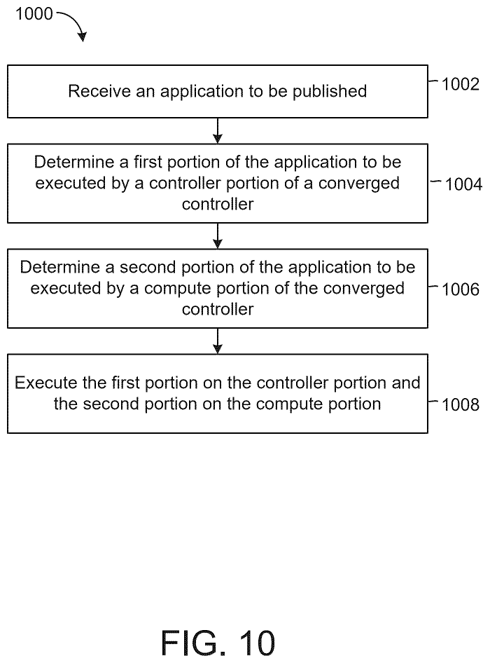

Now referring to FIG. 10, each block of method 1000, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 1000 is described, by way of example, with respect to the system 400 and/or the system 500. However, these methods may additionally or alternatively be executed by any one system, or any combination of systems, including, but not limited to, those described herein.

At block 1002, an application is received to be published. Then, at block 1004, a first portion of the application to be executed by a controller portion of a converged controller is determined. This can be done by, for example, the deployment advisor 520. At block 1006, a second portion of the application is determined to be executed by a compute portion of the converged controller. Determining the first portion and the second portion can be based on functionalities of the application. For example, if the application first analyzes received metadata and then executes controls to field equipment (e.g., the field equipment 312), the first portion can be an analysis portion of the application and can be executed by the compute portion while the execute controls portion can be executed by the controller portion. At block 1008, the first portion is executed on the controller portion of the converged controller and the second portion is executed on the compute portion of the converged controller. In some embodiments, the controller portion executes an entire application and in other embodiments, the compute portion executes the entire application. For example, if the application receives, analyzes, and generates graphs of received metadata from, for example, the sensor 308, the application only runs on the compute portion of the converged controller and/or the device the application is installed and executed on.

By executing the first portion on the controller portion and the second portion on the compute portion, the teachings herein can culminate in online control of industrial equipment (e.g., various pumps, actuators, etc. for oil and gas systems as shown in FIGS. 1-3) in accordance with both said first portion of applications developed in an accelerated, streamlined manner as described herein and also in a manner influenced by advance calculations performed in the second portion of the application executed on the compute portion of a converged controller. The teachings herein can therefore provide for accelerated development, validation, deployment, and online use of a wide variety of control and other applications for industrial controls, including for control of oil and gas equipment.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (i.e., permanent or fixed) or moveable (i.e., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A system, comprising:
a converged controller comprising a controller portion and a compute portion, the converged controller coupled to at least one field equipment; and
a computing platform configured to accelerate creation of an application executable on at least one of the controller portion or the compute portion, the computing platform comprising one or more processors and one or more non-transitory computer-readable media storing program instructions that, when executed by the one or more processors, cause the one or more processors to perform operations comprising:
providing, based on a user input, an application template, the application template selected from a template library,
selecting, based on the user input, a code block from a plurality of code blocks and appending the code block to the application template to create an application,
installing the application on the converged controller, and
executing the application on at least one of the controller portion or the compute portion.

2. The system of claim 1, wherein the plurality of code blocks comprise data quality, reference engine, smart buffering, and anomaly detection.

3. The system of claim 1, wherein the application template is generated based on the user input into a generative machine learning model.

4. The system of claim 1, further comprising an additional converged controller, wherein the one or more processors perform the operations further comprising:
generating a list of devices based on at least the user input, the list of devices including the converged controller and the additional converged controller, the list of devices ordered according to risk and reward metrices of devices included in the list of devices; and
in response to receiving the user input on the list of devices, installing the application on at least one of the converged controller or the additional converged controller.

5. The system of claim 1, wherein the system further comprises a display, the display configured for supervisory control and data acquisition (SCADA).

6. The system of claim 1, wherein the one or more processors perform the operations further comprising:
determining a first portion of the application to be executed by the controller portion and a second portion of the application to be executed by the compute portion, and
executing the first portion on the controller portion and the second portion on the compute portion.

7. The system of claim 1, wherein the one or more processors perform the operations further comprising wrapping the application, the application configured to function on at least one of the converged controller or a cloud computing system.

8. The system of claim 1, wherein the one or more processors perform the operations further comprising in response to creating the application, validating, by one or more simulations within a quality-controlled environment, the application.

9. The system of claim 8, wherein the one or more simulations comprise a physics simulation and a logic simulation.

10. The system of claim 1, wherein the one or more processors perform the operations further comprising in response to installing the application on the converged controller, determining performance of the application on the at least one field equipment and validating the application based on the performance.

11. The system of claim 1, wherein the user input includes at least one of a goal or parameter of the application, the one or more processors to perform the operations further comprising:
generating a subset of the plurality of code blocks according to the at least one of the goal or the parameter of the application; and
in response to receiving the user input, appending at least one code block of the subset of the plurality of code blocks to the application template to create the application.

12. A method, comprising:
selecting, by one or more processors, based at least partially on user input, an application template from a plurality of application templates;
appending, by the one or more processors, at least one code block to the application template to create an application, the at least one code block selected from a plurality of code blocks based at least partially on the user input;
generating, by the one or more processors, the application using the application template;
wrapping, by the one or more processors, the application;
installing, by the one or more processors, the application on at least one converged controller, the at least one converged controller including at least a controller portion and a compute portion, the at least one converged controller coupled to at least one field equipment; and
executing, by the one or more processors, the application on at least one of the controller portion or the compute portion of the at least one converged controller, the application configured to perform at least one of computations using data received from the at least one field equipment or control operations of the at least one field equipment.

13. The method of claim 12, further comprising:
determining, a first portion of the application configured to perform computations;
determining, a second portion of the application configured to control operation of the at least one field equipment;
executing the first portion on the compute portion; and
executing the second portion on the controller portion.

14. The method of claim 12, further comprising:
publishing, by the one or more processors, the application to an application library;
generating, by the one or more processors, a list of a plurality of converged controllers, the list of the plurality of converged controllers ordered according to risk and reward metrices of the plurality of converged controllers;
generating, by the one or more processors, recommendations based on the list of the plurality of converged controllers; and
installing, by the one or more processors, the application on a subset of the plurality of converged controllers according to the recommendations.

15. The method of claim 14, wherein the one or more processors determine the risk and reward metrices according to at least one of geographical location, type of industrial site, cost, efficiency, production output, or computation resources.

16. The method of claim 12, wherein the plurality of code blocks comprise data quality, reference engine, smart buffering, and anomaly detection.

17. The method of claim 12, further comprising validating, by the one or more processors, using one or more simulations, performance of the application.

18. A system, comprising:
a converged controller comprising a controller portion and a compute portion, the converged controller coupled to at least one field equipment;
a display configured to display a user interface; and
a computing platform configured to accelerate creation of an application executable on at least one of the controller portion or the compute portion, the computing platform comprising one or more processors and one or more non-transitory computer-readable media storing program instructions that, when executed by the one or more processors, cause the one or more processors to perform operations comprising:
generating, based on user input received from the display, an application using at least one of an application template or at least one code block selected from a database based on the user input;
installing the application on the converged controller;
executing at least one of a first portion of the application on the controller portion or a second portion of the application on the compute portion; and
generating, based on at least an output of the application, data on the user interface.

19. The system of claim 18, wherein the data includes at least one of graphs or parameters of the at least one field equipment.

20. The system of claim 18, wherein the user input includes at least one of a goal or parameter of the application, the application template and the at least one code block associated with at least one of the goal or the parameter.
